(19) United States
(12) Patent Application Publication
(10) Pub. No.: US 2019/0379232 A1
(43) Pub. Date: Dec. 12, 2019

(54) WIRELESS CHARGING SYSTEM

(71) Applicants: Rostislav LEMDIASOV, Cambridge (GB); Arun VENKATASUBRAMANIAN, Cambridge (GB)

(72) Inventors: Rostislav LEMDIASOV, Cambridge (GB); Arun VENKATASUBRAMANIAN, Cambridge (GB)

(73) Assignees: Cambridge Consultants Limited, Cambridge (GB); Rostislav LEMDIASOV, Cambridge (GB); Arun VENKATASUBRAMANIAN, Cambridge (GB)

(21) Appl. No.: 16/462,955

(22) PCT Filed: Nov. 22, 2017
(86) PCT No.: PCT/GB2017/053513

§ 371 Date: May 22, 2019

(30) Foreign Application Priority Data
Nov. 22, 2016 (GB) 1619739.4

(51) Int. Cl. H02J 7/02; H02J 50/40; H02J 50/12; H04B 5/00

(52) U.S. Cl. CPC H02J 7/025; H02J 50/40; H04B 5/0037; H04B 5/0081; H02J 50/12

(57) ABSTRACT

A wearable device for wirelessly charging a chargeable device, the wearable device comprising: means for generating a magnetic field for wirelessly charging the chargeable device, wherein the magnetic field generating means comprises at least two transmit coils, each configured to generate a respective component of the magnetic field; and means for shaping the magnetic field, in dependence on at least one of a location, orientation and shape of the chargeable device, by configuring the respective magnetic field component generated by each transmit coil, whereby to optimize the magnetic field for charging the chargeable device.

The present invention relates to wireless charging of electronic devices and in particular, but not limited to, wireless charging of body worn or implantable devices using a body-worn charging system.

Current wireless charging systems for medical implants and other wearable devices suffer from a number of limitations. For example, charging of body worn or implant devices can take a long time, e.g. 4 hours, which is inconvenient and often uncomfortable for the patient who has to remain in position for the duration of charging.

Moreover, the charging performance of current charging systems can be affected adversely depending on the orientation of the body-worn or implant device being charged. In many cases, efficient charging of body-worn or implant devices can only be achieved with precise positioning of the charging coil by the user.

Also, it is often necessary for companies to produce multiple different models of body worn wireless charging systems in order to account for different user body types/body morphology, along with different charging coil locations.

Other issues include the tendency of charging systems to cause skin and tissue heating due to their thermal footprint, and the fact that coils can heat up, or waste energy in heating up metallic objects located close to the charging coil.

Accordingly, preferred embodiments of the present invention aim to provide methods and apparatus which address or at least partially deal with the above needs.

In one aspect, the invention provides a wearable device for wirelessly charging a chargeable device, the wearable device comprising: means for generating a magnetic field for wirelessly charging the chargeable device, wherein the magnetic field generating means comprises at least two transmit coils, each configured to generate a respective component of the magnetic field; and means for shaping the magnetic field, in dependence on at least one of a location, orientation and shape of the chargeable device, by configuring the respective magnetic field component generated by each transmit coil, whereby to optimize the magnetic field for charging the chargeable device.

The at least two transmit coils may be mechanically coupled for movement relative to one another whereby to provide the wearable device with flexibility when worn by a user.

Adjacent transmit coils of the at least two transmit coils may be each mechanically coupled to one another, for movement into a plurality of different respective positions relative to one another, to select a position in which, during operation, the adjacent transmit coils are magnetically decoupled from one another, or magnetic coupling (or mutual inductance) between the adjacent coils is minimized.

Adjacent transmit coils of the at least two transmit coils may be mechanically coupled to one another with a coupling configured for rotational movement of at least one of the adjacent coils about an axis and for translational movement of at least one of the adjacent coils relative to the other coil.

The coupling may be configured for controlling an overlap between the adjacent transmit coils, at a given angle, whereby to reduce or minimize magnetic coupling (or mutual inductance) between the adjacent coils.

The magnetic field shaping means may comprise means for controlling a phase difference between respective voltage signals applied to each of the at least two transmit coils.

The magnetic field shaping means may be configured to control a voltage signal applied to each of the at least two transmit coils based on at least one impedance determined for that transmit coil.

The at least one impedance determined for a given transmit coil may comprise a respective impedance determined as each other of the at least two transmit coils is energized independently.

The respective impedance determined as each other of the at least two transmit coils is energized independently may be determined based on a mutual inductance between the given transmit coil and the transmit coil that is being energized independently.

The wearable device may be configured to be worn around the body of a user.

The wearable device may be configured as a belt, skirt, shirt or jacket.

The magnetic field shaping means may be operable to configure the respective magnetic field component generated by each coil to shape the magnetic field generated by the generating means whereby to optimize the magnetic field for charging a chargeable device that is implanted in a body of a user.

The magnetic field shaping means may be operable to configure the respective magnetic field component generated by each coil to shape the magnetic field generated by the generating means whereby to optimize the magnetic field for charging a chargeable device that is not implanted in a body of a user (e.g. a device that is worn on a body of a user).

The magnetic field shaping means may be operable to configure the respective magnetic field component generated by each coil to shape the magnetic field generated by the generating means away from an object other than the chargeable device.

The object other than the chargeable device may be capable of magnetically coupling with one or more of the at least two transmit coils.

According to a further aspect, the present invention provides a device for wirelessly charging a chargeable device the wearable device comprising: means for generating a magnetic field for wirelessly charging the chargeable device, wherein the magnetic field generating means comprises at least two transmit coils, each configured to generate a respective component of the magnetic field; and wherein adjacent transmit coils of the at least two transmit coils are each mechanically coupled to one another, for movement into a plurality of different respective positions relative to one another, to select a position in which, during operation, the adjacent transmit coils are magnetically decoupled from one another, or magnetic coupling between the adjacent coils is minimized.

According to a further aspect, the present invention provides a method for calibrating an apparatus for charging a chargeable device, the apparatus comprising at least two transmit coils, the method comprising: (i) supplying current to energize a given transmit coil of the at least two transmit coils and determining an impedance of each other of the at least two transmit coils while current is supplied to the given transmit coil; (ii) repeating step (i) using each of the at least two transmit coils, in turn, as the given transmit coil; (iii) determining a voltage signal to be applied to each of the at least two transmit coils, based on the impedances determined in steps (i) and (ii); (iv) applying the voltage signals determined in step (iii) to the corresponding transmit coils.

Determining a voltage signal in step (iii) may comprise at least one of: determining a phase difference to be applied between respective voltage signals applied to each transmit coil; and determining a respective voltage amplitude of the voltage signals to be applied at each transmit coil.

Aspects of the invention extend to corresponding systems, methods, and computer program products such as computer readable storage media having instructions stored thereon which are operable to program a programmable processor to carry out a method as described in the aspects and possibilities set out above or recited in the claims and/or to program a suitably adapted computer to provide the apparatus recited in any of the claims.

Each feature disclosed in this specification (which term includes the claims) and/or shown in the drawings may be incorporated in the invention independently of (or in combination with) any other disclosed and/or illustrated features. In particular but without limitation the features of any of the claims dependent from a particular independent claim may be introduced into that independent claim in any combination or individually.

Embodiments of the invention will now be described, by way of example, with reference to the accompanying drawings in which:

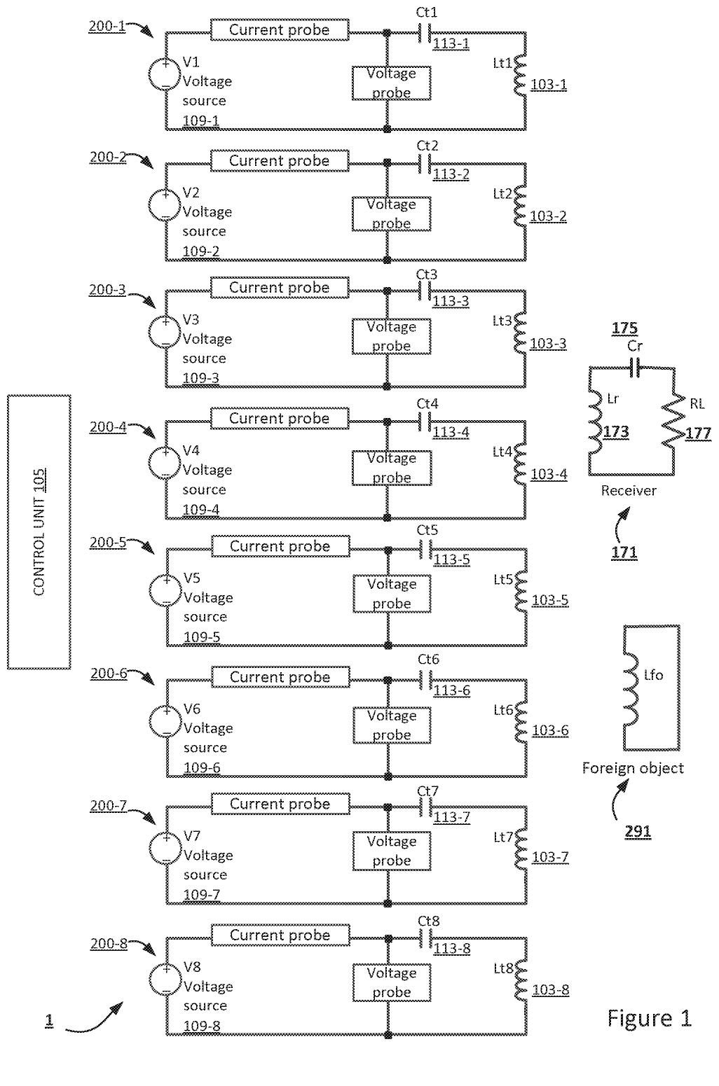

FIG. 1 illustrates a simplified top view of a wireless charging system;

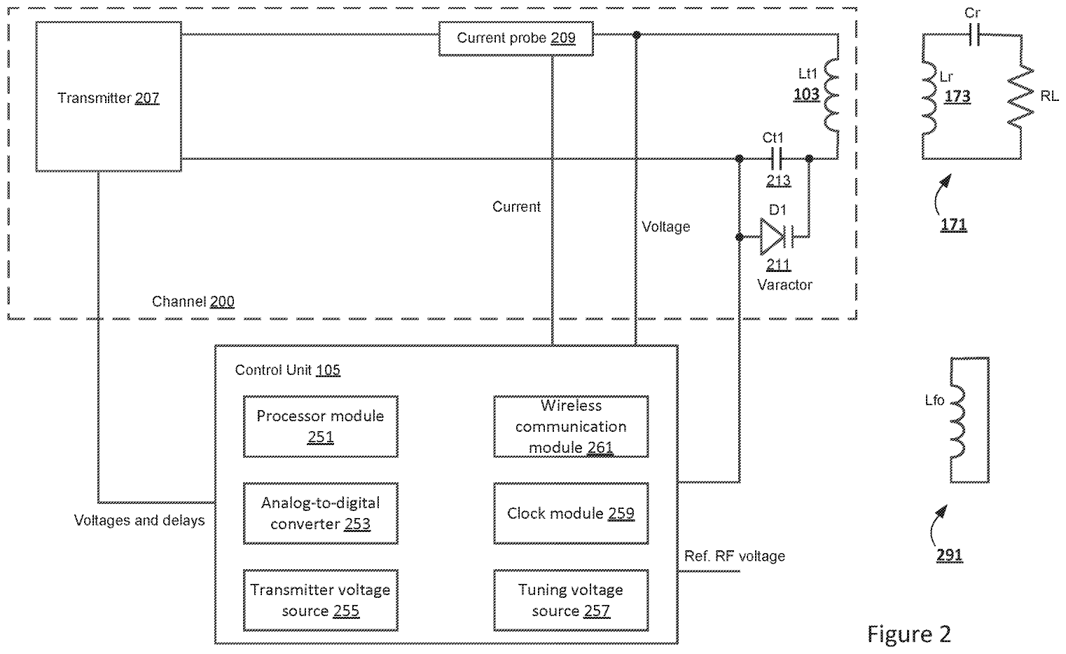

FIG. 2 shows a simplified circuit diagram of one channel of the wireless charging system illustrated in FIG. 1;

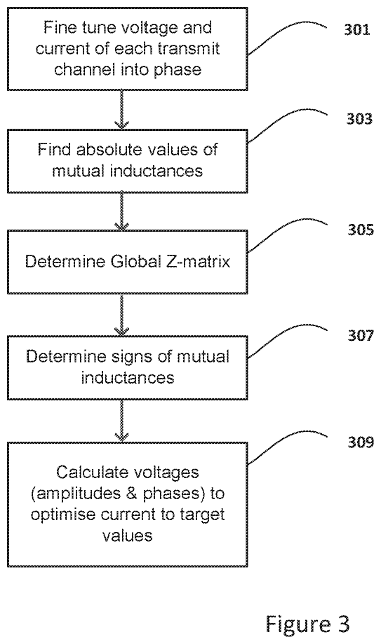

FIG. 3 is a flow chart showing an outline of the calibration procedure;

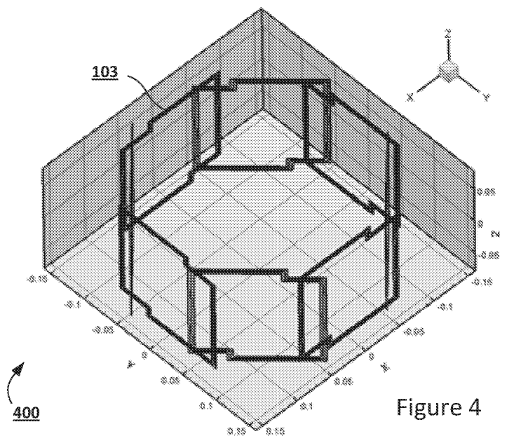

FIG. 4 is an axonometric view of a configuration of an array of transmit coils of a belt configuration;

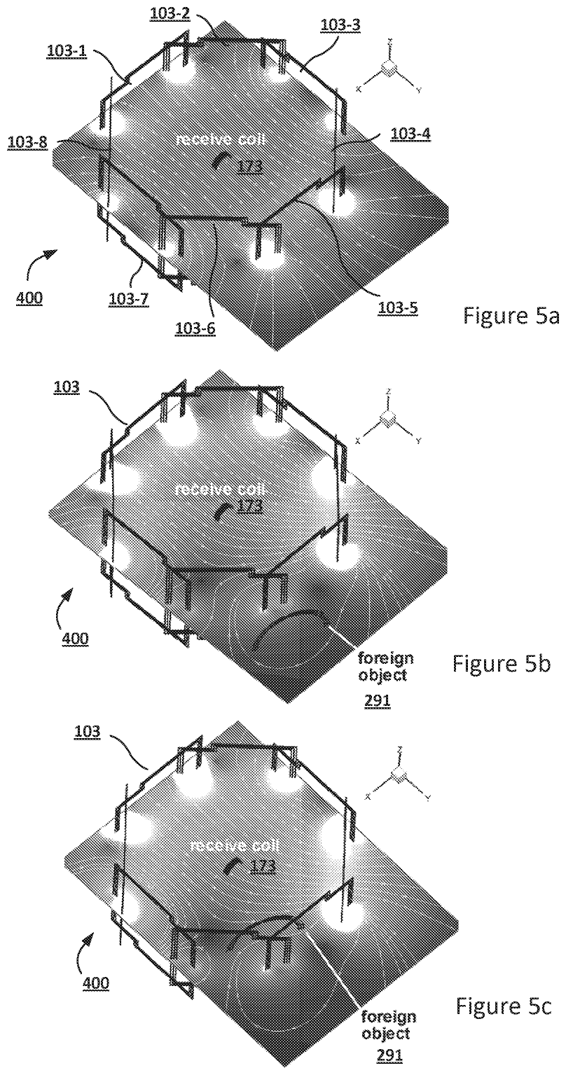

FIGS. 5a to 5c show the resulting magnetic field in the x-y plane of the belt configuration of FIG. 4;

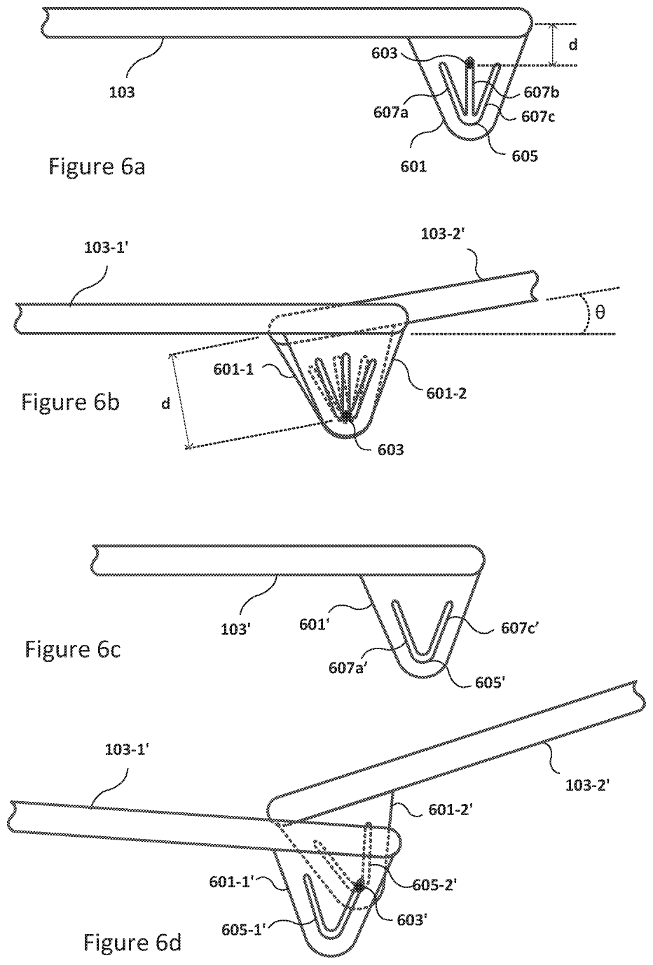

FIGS. 6a to 6d show how adjacent transmit coils of the belt configuration of FIG. 4 are movably attached to one another;

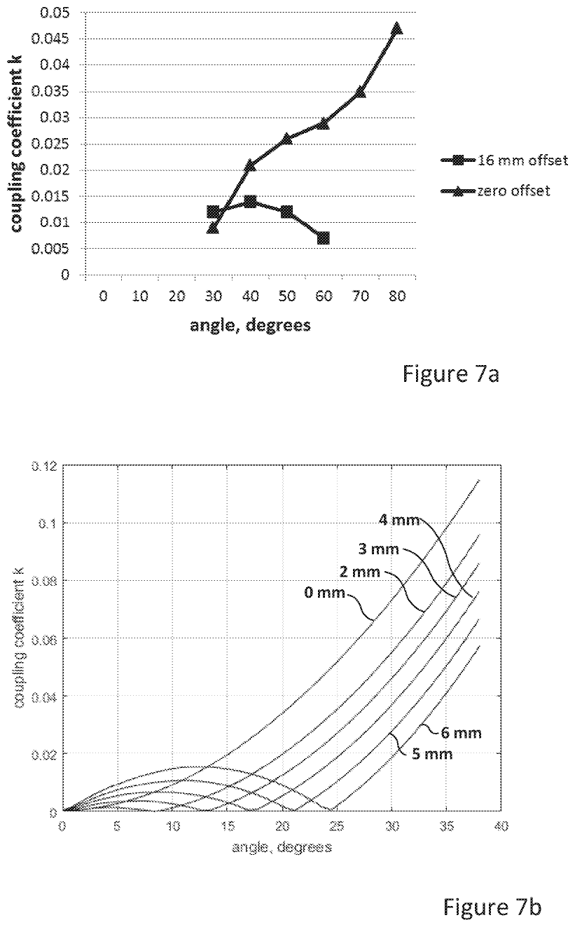

FIGS. 7a and 7b are graphs plotting the coupling coefficient versus angle of the transmit coils; and

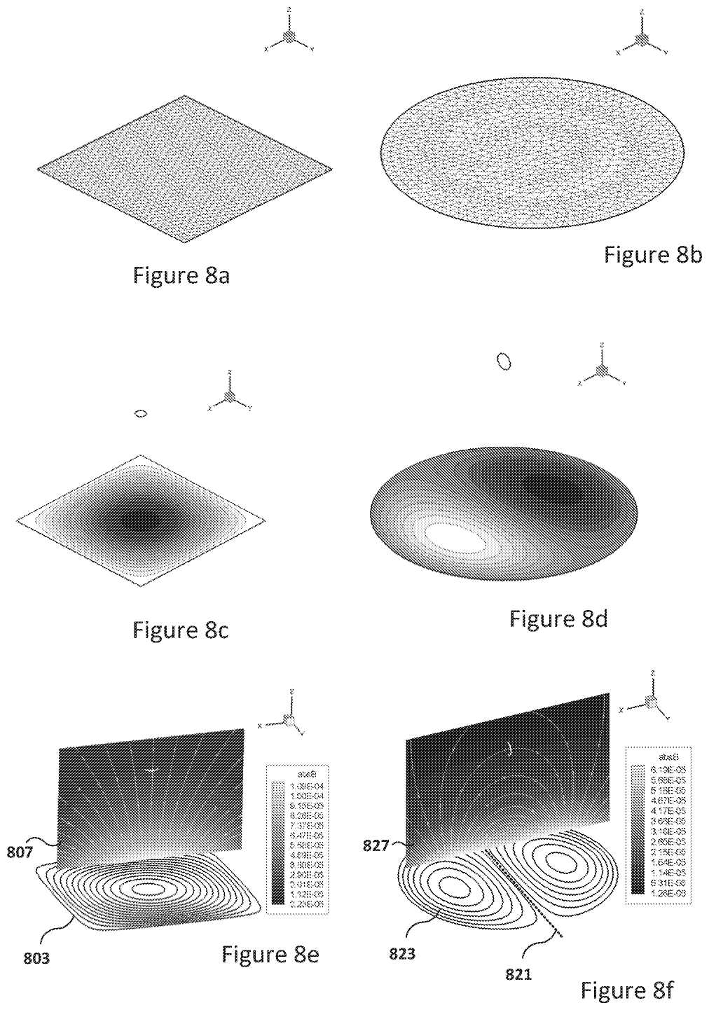

FIGS. 8a to 8f illustrate how a current-carrying surface can be modelled using a stream function method.

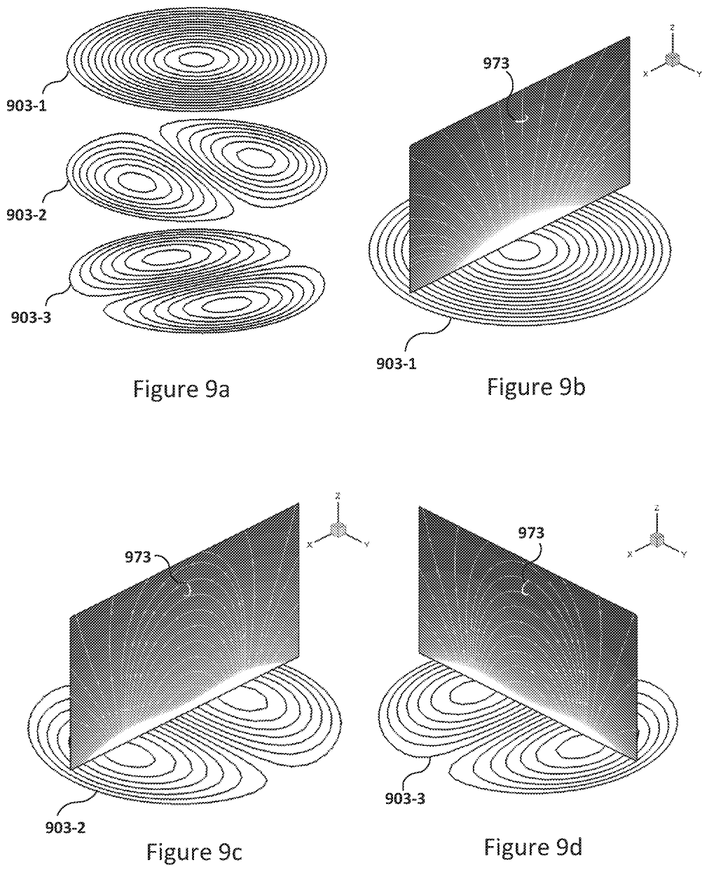

FIGS. 9a to 9d illustrate a flat coil arrangement which can use a field-shaping routine to maximize the magnetic flux through a receive coil of a chargeable device;

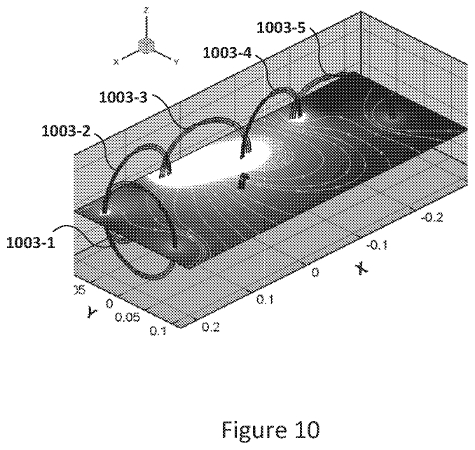

FIG. 10 illustrates an alternative arrangement of transmit coils.

### OVERVIEW

FIG. 1 is a simplified circuit diagram of a wireless charging system 1 which comprises a number of channels 200, each of which is connected to a control unit 105 via one or more connectors (not shown).

Each of the channels 200 comprises a resonant circuit including an inductive transmit coil 103 and a capacitor 113. A voltage is applied to each channel 200 by a voltage source 109. As can be seen, in this embodiment the wireless charging system 1 comprises eight channels 200-1 to 200-8. The eight transmit coils 103-1 to 103-8 have inductances of Lₜ₁ to Lₜ₈ respectively. The eight capacitors 113-1 to 113-8 have capacitances of Cₜ₁ to Cₜ₈ respectively.

Each of the channels 200 comprises a current probe and a voltage probe which are connected to the control unit 105 in order to allow the control unit 105 to obtain current and voltage measurements of each channel 200.

The control unit 105 is configured to control the voltage source 109 of each channel 200 to apply a voltage V to each of the transmit coils 103. When electric current flows in the transmit coils 103, a magnetic field is created by each of the transmit coils 103. As the transmit coils 103 are located in relative proximity to each other (as explained below, adjacent transmit coils 103 preferably overlap with one another), the magnetic fields generated by the transmit coils 103 combine with one another, and thus a resulting magnetic field occurs from the combination of the eight magnetic fields. It can therefore be seen that each of the transmit coils 103 provides a magnetic field component to the resulting magnetic field.

The resulting magnetic field is used to charge a chargeable device 171, via a receive coil 173 of the chargeable device 171. The chargeable device 171 may be, for example, a medical implant such as a pacemaker or a neurostimulation device or a wearable glucose monitor. The resulting magnetic field causes magnetic flux through the receive coil 173 of the chargeable device 171, which in turn causes a current to flow in the receive coil 173 through induction. This current is used to charge a battery (not illustrated) in the chargeable device 171.

The chargeable device 171 also includes a capacitor 175 having a capacitance Cᵣ and a resistor 177 (which may be a physical resistor, or which may represent the resistance present in the circuitry of the chargeable device), the resistor having a resistance R_{L}.

Beneficially, the control unit 105 is configured to detect a foreign object 291 (e.g. metallic objects that interfere with power transfer), and adjust the currents in the transmit coils 103 in order to minimize the effect of the foreign object 291 on charging, by shaping the applied magnetic field away from the foreign object 291.

Beneficially, each of the channels 200 is controlled by the control unit 105 to optimize the magnetic field flux through the receive coil 173 of the chargeable device 171, while keeping the ohmic energy dissipation in the transmit coils 103 low, and also keeping the magnetic flux through the foreign object (if present) to zero (or as low as possible). This is at least partially achieved via a calibration procedure in which measurements of (a) mutual inductances M between transmit coils 103 and the receive coil 173 of the chargeable device 171 and (b) mutual inductances M_{fo} between transmit coils and foreign object mutual inductances are performed. In the calibration procedure the optimal currents for each channel 200 are determined. Therefore, the wireless charging system 1 can, advantageously, recalibrate itself and can send power through the most effective spatial magnetic flux channels. This provides the benefit of avoiding (or at least mitigating) the need for precise manual positioning of the transmit coils 103.

Thus, the wireless charging system 1 beneficially provides a self-calibrating, field-shaping wireless charging system that significantly increases the rate of charge of body worn and implantable devices without violating FCC and FDA regulatory requirements.

Advantageously, the coils can move relative to one another, which provides flexibility as well as the possibility to magnetically decouple adjacent transmit coils. A coupling provided between adjacent coils may be configured to allow multiple degrees of freedom of movement of the transmit coils 103. The coupling is also advantageously configured to magnetically decouple adjacent transmit coils 103.

Channel Circuitry Design

FIG. 2 shows a simplified circuit diagram of a channel 200 and the control unit 105 of the wireless charging system 1 illustrated in FIG. 1. In this example, the channel 200 comprises a resonant circuit that can be used to generate a magnetic field for charging the chargeable device 171.

The channel 200 comprises a transmit coil 103 having an inductance Lu. The transmit coil 103 is powered by a transmitter 207.

The channel 200 is connected to a control unit 105 configured to tune the channel 200 by adjusting its resonant frequency and to control the voltage signal supplied by the transmitter 207.

The control unit 105 comprises a processor module 251 (optionally comprising a memory), an analogue-to-digital converter 253, a transmitter voltage source 255, a tuning voltage source 257, a clock module 259 and a wireless communication module 261.

The processor module 251 of the control unit 105 obtains measurements of the current and voltage on an output of the transmitter 207. The analogue-to-digital converter 253 is configured to convert the current and voltage measurements from analogue to digital so that the processor module 251 can interpret them. As shown in FIG. 2, the current measurement is obtained from a current probe 209 disposed on the output of the transmitter 207.

The wireless communication module 261 is configured to receive a wireless signal transmitted from the chargeable device 171, where in this example the signal includes information relating to the load voltage V_{receive} 173. The wireless communication module 261 is configured to then provide the information relating to the load voltage V_{receive} on the receive coil 173 to the processor module 251.

The processor module 251 is configured to use the measured current I and voltage V at the output of the transmitter, along with the information relating to the voltage V_{receive} on the receive coil 173, to determine optimal current for the channel 200. The processor module 251 is therefore configured to calculate the appropriate output voltages and delays for the transmitter voltage source 255 and the tuning voltage source 257 in order to generate the optimal current for the channel 200. The transmitter voltage source 255 controls the voltage and current output by the transmitter 207, including the phase difference between the voltage and current. The transmitter voltage source 255 uses the clock module 259 to modulate the voltage signal for the transmitter 207.

The channel 200 further comprises a varactor diode 211 (labelled D₁) and a capacitor 113 having a capacitance Cₜ₁. The control unit 105 is configured to voltage-tune the transmit coil 103 by using the varactor diode 211. The tuning voltage source 257 of the control unit 105 controls the voltage applied to the varactor diode, which in turn controls the capacitance of the varactor diode 211, allowing the resonant frequency of the channel 200 to be tuned.

While the control unit 105 may be configured to voltage-tune the transmit coil 103 by using the varactor diode 211, alternatively or additionally, the control unit 105 may configured to voltage-tune the transmit coil 103 using any suitable method, such as via a capacitor bank.

The components of the control unit 105 can be provided in software, hardware, or a mixture of the two.

The wireless charging system 1 is configured to maximize a figure-of-merit η defined as ratio of the square of the voltage V_{receive} on the receive coil 173 to the power dissipation Pₜᵣₐₙₛₘᵢₜ in the transmit coils 103 as follows:

$$η = \frac{{\vert {V}_{receive} \vert}^{2}}{{P}_{transmit}}$$

where the power dissipated (as heat) in the transmit coils is given by:

$${P}_{transmit} = \frac{1}{2} {\sum }_{i} {\sum }_{j} {I}_{i} {R}_{ij} {I}_{j}$$

where Rᵢⱼ is a resistance matrix representing the resistances of the transmit coils and Iᵢ and Iⱼ are components of the current vector.

It can be shown that maximizing the figure-of-merit η is equivalent to minimising a cost function ϕ with high value of coefficient γ.

$$Φ = \frac{1}{2} {( {\sum }_{n} ( ( B \cdot n ) - {B}_{des} ) )}^{2} + γ {P}_{transmit} - λ {\sum }_{n} {M}_{fon} {I}_{n}$$

where B represents the magnetic field from all transmit coils (i.e. coils 1 to n) at the location of the receive coil, n is a unit vector parallel to the axis of the receive coils, B_{des} is a desired value of the magnetic field, λ is the Lagrange multiplier, M_{fon} are mutual inductances between each transmit coils and foreign object, and Iₙ is the current in each of the transmit coils (i.e. coils 1 to n).

The magnetic field B at the location of receive coil is given by:

$$B = {\sum }_{n} {c}_{n} {I}_{n}$$

where vectors cₙ relate coils currents with corresponding magnetic fields and can be calculated from the Biot-Savart law. In other words, the contribution to the magnetic field B, from each of the n transmit coils, at the location of receive coil, is equal to the current Iₙ in each of the n transmit coils 103 multiplied by a parameter cₙ for that transmit coil. The parameter cₙ for each transmit coil depends on the permeability of the medium between that transmit coil and the receive coil; and is also dependent on the geometry of the transmit coil.

When minimizing the cost function ϕ, one arrives at the equations for the vector of currents:

$$( \begin{matrix}R & - {M}_{fo} \\ {M}_{fo} & 0\end{matrix} ) ( \begin{matrix}I \\ λ\end{matrix} ) = ( \begin{matrix}M \\ 0\end{matrix} )$$

The solution of this equation is current I that is yet not scaled. In order to scale it, we require the power dissipation on the load to be P_{L}:

$${P}_{L} = \frac{1}{2} {\vert {i}_{r} \vert}^{2} {R}_{L} = {C}^{2} \frac{{R}_{L} {{ω}_{0}^{2} ( {M}^{T} I )}^{2}}{2 {( {R}_{r} + {R}_{L} )}^{2}}$$

where is C is an unknown coefficient, Rᵣ is the resistance of receive coil, R_{L} is the load resistance, iᵣ is the current in the receive coil. Expression for the scaled current needed to provide power P_{L} into the load is then:

$${I}_{scaled} = \sqrt{\frac{2 {P}_{L}}{{R}_{L}}} \frac{( {R}_{r} + {R}_{L} )}{{ω}_{0} {M}^{T} I} \cdot I$$

From the vector of currents I_{scaled} the absolute values of voltages that need to applied to the system can be calculated:

V_{abs}=|Z·I_{scaled}|

and delays:

$${d}^{*} = - \frac{1}{{ω}_{0}} phase ( Z \cdot {I}_{scaled} )$$

In practice, we make sure that the delays are positive numbers and that the smallest delay is zero. To do that we find the smallest delay d₀* in vector d* and shift the values of delay by the value of d₀*;

dₙ=dₙ*−d₀*,

As we provide square wave in the input, we need to scale the voltage by a factor of π/2

$${V}_{square} = \frac{π}{2} {V}_{abs}$$

Calibration Procedure

FIG. 3 is a simplified flow chart illustrating a procedure which may be used to assist in the calibration of each channel 200. The calibration procedure may be used, advantageously, in the measurement of the vector of the mutual inductance M, between each transmit coil and the chargeable device, and of the mutual inductance, M_{fo}, between each transmit coil and a foreign object (if present).

As seen in FIG. 3, at step 301 each the channels 200 is “fine-tuned”, in order to bring the voltage and current in the respective transmit coil 103 into phase.

In order to fine-tune each channel individually current is only provided to the channel being tuned and all the other channels are detuned. The channels may be detuned by electronically disconnecting the circuits using PIN diodes, MOSFETs or any other appropriate methods. The channel in question is then tuned by adjusting the varactor diode 211 until the measured impedance of the channel 200 is real, with no imaginary component (or negligible imaginary component). This process is then repeated for each of the channels until all channels have been fine-tuned. If the coil cannot be fine-tuned or the varactor voltage value is far from the values normally seen, then this may indicate the presence of the foreign object. In this case the varactor voltage may be set to a pre-set or default value.

At step 303, the absolute value of the mutual inductance between each of the transmit coils 103 and the receive coil 173 is determined (with all other channels detuned), along with the absolute value of the mutual inductance between each of the transmit coils 103 and any foreign object.

In more detail, current is only provided to the transmit coil 103 for which a measurement is being made. With all other channels detuned, the impedance of the transmit coil 103 is measured, and from the impedance measurement the absolute value of mutual inductance between that transmit coil 103 and the receive coil 173 is calculated.

For channel m, the impedance seen in the presence of the receive coil and the foreign object is:

$${Z}_{mm} = {R}_{tm} + \frac{{ω}_{0}^{2} {M}_{mr}^{2}}{{R}_{r} + {R}_{L}} - \frac{j {ω}_{0} {M}_{fom}^{2}}{{L}_{fo}}$$

where Rₜₘ is the resistance of the transmit coil m, Mₘᵣ is the mutual inductance between transmit coil m and receive coil, M_{fom} is the mutual inductance between transmit coil m and foreign object, L_{fo} is the inductance of the foreign object, which is generally unknown. As we can measure the Zₘₘ and we know the value of Rₜₘ, then we calculate absolute values |Mₘᵣ| and |M_{fom}|:

$$\vert {M}_{mr} \vert = \frac{\sqrt{{R}_{r} + {R}_{L}}}{{ω}_{0}} \sqrt{Re ( {Z}_{mm} ) - {R}_{tm}}$$

$$\vert {M}_{fom} \vert = \sqrt{{L}_{fo}} \sqrt{- \frac{Im ( {Z}_{mm} )}{{ω}_{0}}}$$

where \sqrt{L_{fo}} is an unknown coefficient that is common for all transmit coils. As its value is common for all transmit coils, it is not necessary to determine this value—for example it can be set to unity.

This process is then repeated for each channel.

The mutual inductance Mₘᵣ between transmit coil m and receive coil is dependent on the real part of the impedance Zₘₘ because the receive coil of the chargeable device is tuned to the same frequency as the transmit coils. Furthermore, the mutual inductance M_{fom} between transmit coil m and foreign object is dependent on the imaginary part of the impedance Zₘₘ because the foreign object is not tuned to the same frequency as the transmit coils.

At step 305, a global impedance Z-matrix of the wireless charging system is determined. In more detail, electrical current is provided to a first (activated) one of the transmit coils 103 (all other channels are detuned), and voltage measurements are performed on all of the channels. The impedance (Z_{cr}=Re(Z_{cr})+Im(Z_{cr})) of each of the channels 200 then calculated (where ‘c’ is the activated channel and ‘r’ is the measurement channel). The impedance is calculated by dividing the measured voltages of each measured channel by the current being supplied to the activated channel. This provides the first column of the Z matrix.

This process is repeated with each of the other channels activated, until the full impedance matrix of the system has been determined.

Expression for the Z matrix is:

$${Z}_{mn} = j {ω}_{0} {M}_{mn} + \frac{{ω}_{0}^{2} {M}_{mr} {M}_{nr}}{{R}_{r} + {R}_{L}} - \frac{j {ω}_{0} {M}_{fom} {M}_{fon}}{{L}_{fo}}$$

with 1≤m, n≤N, where N is the number of channels.

At step 307, the signs of the mutual inductances calculated at step 303 are determined. This may be achieved for the mutual inductance between each transmit coil and the chargeable device by first identifying the channel with the highest absolute value of mutual inductance abs(M), for example channel m. The real part of the inductance relative to channel m is then looked up in the Z matrix for each other channel i (i.e. Re(Zₘᵢ) is found for each channel i< >m). If Re(Zₘᵢ)

$$( which is \frac{{ω}_{0}^{2} {M}_{mr} {M}_{nr}}{{R}_{r} + {R}_{L}} )$$

has a positive sign, then the mutual inductance Mᵢ also has a positive sign.

Similarly, for the foreign object inductance this may be achieved for the mutual inductance between each transmit coil and the chargeable device by first identifying the channel with the highest absolute value of foreign object related mutual inductance abs (M_{fo}), for example channel m. The imaginary part of the inductance relative to channel m is then looked up in the Z matrix for each other channel i (i.e. Im(Zₘᵢ) is found for each channel i< >m). If Im(Zₘᵢ)

$$( which is - \frac{{ω}_{0} {M}_{fom} {M}_{fon}}{{L}_{fo}} )$$

has a negative sign, then the foreign object related mutual inductance M_{fo} has a positive sign.

At step 309, the current in each channel 200 is optimized to target values. Specifically, the target optimal currents I_{scaled} are determined and the impedance Z-matrix is used to calculate ‘optimal’ voltages (amplitudes V_{abs} and delays d) required to provide the target optimal currents. This is done using the equations outlined above—in summary the scaled current I_{scaled} needed to provide power P_{L} into the load is:

$${I}_{scaled} = \sqrt{\frac{2 {P}_{L}}{{R}_{L}}} \frac{( {R}_{r} + {R}_{L} )}{{ω}_{0} {M}^{T} I} \cdot I$$

The absolute values of voltages are given by:

V_{abs}−|Z·I_{scaled}|

and delays are given by:

$${d}^{*} = - \frac{1}{{ω}_{0}} phase ( Z \cdot {I}_{scaled} )$$

Voltage amplitudes are typically calculated for square waves V_{square} and delays d are calculated to provide the required phase. The ‘optimal’ voltages (amplitudes and delays) are applied to the corresponding channel and the resulting currents are measured at the output. The optimal voltages may then be adjusted, if necessary, to bring current values closer to the target values and this procedure may be repeated iteratively several times (if necessary) to arrive at the optimal current and thereby calibrate the channel.

After the calibration procedure is performed, the calculated voltages and delays are applied to the transmitters 207 in order to start charging the chargeable device 171.

It can be seen that, in order to maximize the efficiency of power transfer to the chargeable device, it is desirable to minimize the imaginary part of the impedance as this is associated with the foreign object.

During charging of the chargeable device 171, the currents and voltages in each channel 200 are monitored. If it is determined that any of the measured currents in the channels deviate from the target current for that respective channel, the calibration process is performed again. Preferably, this determination is made periodically according to a predefined time period T. The determination may involve determining whether the measured currents in the channels deviate from the target current for that respective channel by a threshold amount.

The charging system advantageously maximizes the efficiency of power transfer as a ratio of power transmitted to a load to the total input power. It minimizes amount of power lost in ohmic heating of the transmit coils thereby lowering the thermal footprint of the wearable coil.

The calibration essentially functions as a field-shaping routine in which the magnetic field of the transmit coils is shaped away from any foreign objects.

Belt Example

In one particularly beneficial example, the channels 200 are each implemented as part of a ‘charging belt’ configuration, for example for securing around the body of a person having a medical implant, or the like, that requires charging.

FIG. 4 is an axonometric view of a configuration of an array of transmit coils 103 forming a belt configuration 400 for a charging belt. The transmit coils 103 are disposed in a row, such that when the belt is in use, for example wrapped around a patient, the array of transmit coils 103 disposed in a substantially annular shape. In order to support the belt implementation, the configuration 400 is flexible and so neighboring coils can move relative to each other.

The each of the transmit coils 103 is arranged to overlap with its neighbouring coils. In this embodiment, the overlapping parts of the coils are complementarily shaped in order to facilitate overlapping while keeping the coils aligned with one another.

Each of the transmit coils 103 is connected to the control unit (not shown) via one or more connectors (not shown). A resulting magnetic field occurs within a central area bounded by the belt configuration 400.

FIGS. 5a to 5c show the resulting magnetic field in the x-y plane of the belt configuration of FIG. 4, where eight transmit coils 103 are arranged in symmetrically in an overlapping configuration.

FIG. 5a shows the magnetic field when the receive coil 173 of the chargeable device 171 is located in the middle of the annular array of transmit coils 103. In this case, the receive coil 173 of the chargeable device 171 is oriented substantially parallel to the transmit coils 103-1 and 103-5 and substantially perpendicular to the transmit coils 103-3 and 103-7. This means that lines of magnetic flux emitted from the parallel coils 103-1 and 103-5 will intersect the receive coil 173 to a greater degree than the lines of magnetic flux emitted from transmit coils 103-3 and 103-7.

Accordingly, the mutual inductance between the receive coil 173 and transmit coils 103-1 and 103-5 will be have the highest values and the mutual inductance between the receive coil 173 and the perpendicular transmit coils 103-3 and 103-7 will have the lowest values. The mutual inductance between the receive coil 173 and the remaining four transmit coils will be between these highest and lowest mutual induction values. As a result of the calibration procedure, the transmit coils with the highest mutual inductance of the receive coil 173 will be excited the most, receive the highest current, and the transmission coils with the lowest mutual induction of the receive coil 173 will be excited the least, receive the lowest current. As a result, as shown in FIG. 5a, the magnetic field runs predominantly in alignment with the y axis.

FIG. 5b shows a situation in which a foreign object 291 is located near transmit coils 103-5, 103-6 and 103-7. In this case, the foreign object 291 has a high mutual inductance with the transmit coils nearest to it. Therefore, activating the nearest transmit coils 103-5, 103-6 and 103-7 would result in a loss of power transfer efficiency due to the interaction with the foreign object 291. This means that the magnetic field configuration shown in FIG. 5a is not an optimal configuration for the situation illustrated in FIG. 5b.

Therefore, in FIG. 5b the calibration procedure is used to determine that transmit coils 103-5, 103-6 and 103-7 have a strong mutual inductance with the foreign object 291, and therefore these coils are minimally activated. The remaining transmit coils are activated more strongly than in FIG. 5a in order to maximize the magnetic flux through the receive coil 173. The lines of the magnetic field are arranged as to keep the magnetic flux through the foreign object as zero. Efficiency of the power transfer drops compared to a situation of FIG. 5a.

In FIG. 5c, the foreign object 291 is located within the annular array of transmit coils 103. In a similar way to FIG. 5b, the foreign object 291 has a high mutual inductance with the transmit coils located closest to it, in this case transmit coils 103-5, 103-6 and 103-7. Therefore, as a result of the calibration procedure, these nearby transmit coils are minimally activated and the remaining coils are activated more strongly in order to maximize the magnetic flux intersecting the receive coil 173.

In FIGS. 5a, 5b and 5c, the transmit coils 103 are excited with phase so that the magnetic fields at the location of the receive coil add up, i.e. the magnetic fields combine constructively. When the foreign object 291 is present in the system, then the currents in the transmit coils are controlled with the aim of shaping the magnetic field to maximize magnetic flux through the receive coil 173 and minimizing the magnetic flux through the foreign object 291. Again, the lines of the magnetic field avoid passing through the foreign object. Efficiency of the power transfer is also lower than in a situation of FIG. 5a.

It is noted that similar field shaping can be achieved when the transmit coils are oriented in a different manner to that shown in FIGS. 5a-c. In particular, the field-shaping routine can be used to achieve shaping of a magnetic field emitted by a flat antenna, allowing greater efficiency for charging devices at different orientations and locations with respect to the flat antenna.

Decoupling Transmit Coils

The transmit coils 103 couple to each other due to mutual inductance. The current flowing in one of the transmit coils causes electromotive voltages on other transmit coils. Therefore, magnetic decoupling is used to minimize the mutual inductance between transmit coils 103 and thus minimize the additional voltages needed to compensate for these induced electromotive voltages.

FIGS. 6a to 6d show how adjacent transmit coils 103 of the belt configuration of FIG. 4 can be movably attached to one another, where a coupling provided between adjacent coils, comprising an offset hinge arrangement, is used in order to achieve decoupling.

FIG. 6a shows part of a transmit coil 103 and having a mount 601 attached at an end. The mount 601 includes a slot 605 which is configured to receive a hinge element 603. The hinge element 603 is adapted to connect the mount 601 to another mount of an adjacent coil in a rotatable manner about an axis (which may be coaxial with the hinge element 603). The hinge element 603 is also adapted to be movable to different positions in the slot 605, thereby allowing the distance d between the coil 103 and the axis to be changed.

In this example, the slot 605 comprises three arms 607a, 607b and 607c. Arm 607b is perpendicular to the transmit coil 103, while arms 607a and 607c are set at different angles to the transmit coil 103 to provide additional degrees of freedom of movement. Arm 607a is set at an angle of approximately 60 degrees from the transmit coil 103, and arm 607c is set at an angle of approximately 120 degrees from the transmit coil 103. In FIG. 6b, adjacent transmit coils 103-1 and 103-2 are each mounted to a respective mount 601-1 and 601-2. The mounts 601-1 and 601-2 are movably attached to one another by the axis 603. The location of the axis with respect to the coils determines how the coils will move relative to one another when the angle between them changes. In this example, the angle between the transmit coils 103-1, 103-2 is defined as the angle away from parallel, and therefore in FIG. 6b the angle between the transmit coils 103-1, 103-2 is 20 degrees.

The axis is offset from the coils by 5 millimeters, d=5 mm. FIG. 6b shows the transmit coils at an angle of 20 degrees (θ=20 degrees), and with the transmit coils 103 overlapping one another. The greater the offset distance d of the axis from the coils, the more the coils will overlap has the angle between them increases. The coupling between transmit coils 103-1 and 103-2 (including the mounts 601 and slots 605) therefore allows translational movement of the transmit coil 103-1 relative to transmit coil 103-2.

The hinge element 603 can comprise, for example, a rod adapted to pass though slots of two mounts 601 of two respective coils. Alternatively or additionally, the hinge element 603 can comprise at least one fixing element, such as a screw, for fixing the position of the hinge element 603 relative to the slots 605.

FIG. 6c shows a mount 601′ having an alternative slot configuration, where the slot 605′ comprises two arms 607a′ and 607c′ equivalent to arms 607a and 607c in FIGS. 6a and 6b.

The slot 605′ also allows translational movement of a transmit coil 103 relative to an adjacent transmit coil 103, although with one fewer degrees of freedom as it does not include a perpendicular arm equivalent to arm 607b.

FIG. 6d shows adjacent transmit coils 103-1′ and 103-2′ having mounts 601-1′ and 601-2′ movably attached to one another by a hinge element 603′. As can be seen in FIG. 6d, by varying the position of the hinge element 603′ in each of slots 605-1′ and 605-2′, translational movement of the transmit coil 103-1 relative to transmit coil 103-2 can be achieved.

FIG. 7a is a graph plotting the coupling coefficient against angle (θ) of for two overlapping spiral coils for two different axis offset distances d. The angle θ is shown on the x axis, and the coupling coefficient k is shown on the y-axis. The triangular graph points indicate an arrangement where the axis offset is zero. As shown in FIG. 7a, measurements for the zero offset arrangement were obtained, starting at 30 degrees and then every 10 degrees up to 80 degrees. At 30 degrees the coupling coefficient is relatively low, with k being equal to about 0.01. The coupling coefficient increases as the angle θ increases, and at 80 degrees the coupling coefficient is equal to approximately 0.045.

The square graph points indicate measurements of the coupling coefficient obtained for the arrangement shown in FIGS. 6a and 6b, where the axis offset is 16 millimeters from the coils. Measurements for the 16 mm offset arrangement were obtained starting at 30 degrees and then every 10 degrees up to 60 degrees. At 30 degrees, the coupling coefficient k was of a similar value to the zero offset arrangement, being equal to just over 0.01. However, at 40 degrees the coupling coefficient only increased slightly and at 50 and 60 degrees the coupling coefficient decreased each time.

FIG. 7b is a graph plotting the coupling coefficient against angle (θ) of two overlapping spiral coils for six different axis offset distances d. The graph shows separate plot lines for the 6 different axis offsets, from 0 millimeters to 6 millimeters.

As shown in FIG. 7b, with an axis offset of 0 millimeters the coupling coefficient continuously increases with increasing angle. However, with an offset of 2 millimeters, the coupling coefficient only slightly increases then decreases back to zero at approximately 8 degrees. This is herein referred to as a null value of coupling. After eight degrees the coupling coefficient continuously rises.

As can be seen in FIG. 7b, the angle at which the null value of coupling occurs increases as an axis offset increases. For an axis offset of 3 millimeters, the null value of coupling occurs at approximately 17 degrees. At an axis offset of 6 millimeters the null value of coupling occurs at approximately 25 degrees.

The null value of coupling means that the neighbouring transmit coils have a minimal value of mutual induction. Accordingly, based on these results, an appropriate axis offset can be selected based upon the intended arrangement of transmit coils 103, such that the null value of coupling occurs at the angle at which the transmit coils are likely to be oriented. This means that the neighbouring transmit coils can be controlled to have minimal mutual inductance, and are hence decoupled from one another.

The decoupling of neighbouring transmit coils allows the voltages on the outputs of the transmitters to be minimized, which increases safety and efficiency.

Optimal Transmit Coil Design Using Stream Function Method.

The transmit coils 103 can advantageously be designed according to a stream function method. FIGS. 8a to 8f illustrate how a current-carrying surface can be modelled using the stream function method.

In FIGS. 8a and 8b, the current-carrying surface is numerically discretized into triangular mesh. Rotational current elements are then defined on the meshes. In FIG. 8a a 15×15 cm square coil is simulated, and in FIG. 8b a round coil with 15 cm in diameter is simulated. In each simulation, receive coils are positioned directly above the current-carrying surface. The current values are optimized to minimize the cost function:

$$Φ = \frac{1}{2} {( {\sum }_{n} ( ( B \cdot n ) - {B}_{des} ) )}^{2} + γ {P}_{transmit}$$

Stream functions for the two examples are shown in FIGS. 8c and 8d.

The wires of a transmit coil are then laid out along the levels of the stream function, as shown at 803 and 823 in FIGS. 8e and 8f respectively. The magnetic field emitted by the transmit coil 803 can then be simulated, as shown at 807 and 827.

As can be seen in FIG. 8e, the magnetic field lines above the central part of the coil 803 are substantially parallel to the z axis, and therefore run perpendicular to the x-y plane in which the coil lies.

Once the layout of the wires has been established, it is possible to calculate estimates for the inductance and resistance of the coil. Table 1 shows the results of a comparison of simulated and measured results for the simulated coil of FIG. 8e. In order to obtain the results, a prototype of the coil was made out of AWG-18 magnet wire and its parameters were measured.

TABLE 1
Comparison of simulated and measured results, coil 803.

| | | | Lₘₑₐₛ, μH | L_{meas,DC}, μH |
|---|---|---|---|---|
| Rₑₛₜᵢₘₐₜₑ, Ω | Rₘₑₐₛ, Ω | Lₑₛₜᵢₘₐₜₑ, μH | (at 6.78 MHz) | (at 10 kHz) |
| 0.95 | 3.30 | 17.4 | 20.4 | 18.5 |

The stream function method uses the Biot-Savart law to obtain the above inductance estimate Lₑₛₜᵢₘₐₜₑ, where high frequency effects are generally not included. Therefore the stream function method can be seen as a “DC method” as it tends to compare best with low-frequency measurement of inductance L_{meas,DC}. The resistance estimate is made solely based on the skin effect and can therefore be much lower than the measurement Rₘₑₐₛ.

The stream function method advantageously maximizes the magnetic flux incident on the receive coil of the chargeable device.

FIG. 8d shows the modelling of a stream function for a an alternative coil design, and FIG. 8f shows a corresponding modelled coil 823 and its resulting magnetic field 827.

The coil 823 of FIG. 8f comprises two symmetrical halves, where in each half the wire follows an orbital path around a central point. The axis of symmetry of the coil 823 is shown in FIG. 8f at 821. The current paths in the coil 823 are also symmetrical, and so in either half of the coil the magnetic field passes though the coil in opposite directions, as can be seen in the lines of the magnetic field 827 in FIG. 8f.

As can be seen in FIG. 8f, the magnetic field lines above the central part of the coil 823 are substantially parallel to the x axis, and therefore run parallel to the x-y plane in which the coil lies. Table 2 shows the results of a comparison of simulated and measured results for the simulated coil of FIG. 8f.

TABLE 2
Comparison of simulated and measured results, coil 823.

| | | | Lₘₑₐₛ, μH | L_{meas,DC}, μH |
|---|---|---|---|---|
| Rₑₛₜᵢₘₐₜₑ, Ω | Rₘₑₐₛ, Ω | Lₑₛₜᵢₘₐₜₑ, μH | (at 6.78 MHz) | (at 10 kHz) |
| 0.63 | 1.71 | 6.52 | 8.10 | 7.48 |

The detection of foreign object and shaping the field away from such objects allows the wastage of transferred energy in foreign objects to be minimized.

Alternative Transmit Coil Arrangements

FIGS. 9a to 9d illustrate a flat coil arrangement for the wireless charging system 1 of FIG. 1 which can use the above-described field-shaping routine to maximize the magnetic flux through a receive coil of a chargeable device.

FIG. 9a is an exploded view of an array of transmit coils 903-1, 903-2 and 903-3. This array may be used instead of or in addition to the array illustrated in FIG. 4 and FIGS. 5a-5c.

In the array, the transmit coils 903-1, 903-2 and 903-3 are positioned next to one another. Preferably, the transmit coils 903-1, 903-2 and 903-3 are arranged such that their central axes are aligned. Transmit coil 903-1 is a round coil for which, in a similar way to the square coil 803 described above, the magnetic field in the center runs perpendicular to the plane in which the square coil lies. In contrast, transmit coils 903-2 and 903-3 are based on the alternative coil design 823, for which the magnetic field runs parallel to the plane in which the coil lies and perpendicular to the axis of symmetry of the alternative coil design 823.

Transmit coils 903-2 and 903-3 are arranged such that their axes of symmetry are perpendicular. Therefore, above the array, each of the three coils 903a, 903b and 903c produces magnetic fields that are perpendicular to each other. This advantageously means that, irrespective of the orientation of a receive coil, at least one of the transmit coils in the array will be coupled to the receive coil.

In FIG. 9b, a receive coil 973 is positioned parallel to the flat coil arrangement and parallel to the xy plane. In this case, in order to maximize the magnetic flux through the receive coil 973, round coil 903-1 is primarily activated (transmit coils 903-2 and 903-3 are not shown), causing the magnetic field in line with the center of the flat coil arrangement to run perpendicular to the flat coil arrangement and the xy plane.

In FIG. 9c, the receive coil 973 is positioned perpendicular to the flat coil arrangement and parallel to the yz plane. In this case, in order to maximize the magnetic flux through the receive coil 973, coil 903-2 is primarily activated (transmit coils 903-1 and 903-3 are not shown), causing the magnetic field in line with the center of the flat coil arrangement to run parallel to the flat coil arrangement and perpendicular to the yz plane.

In FIG. 9d, the receive coil 973 is positioned perpendicular to the flat coil arrangement and parallel to the xz plane. In this case, in order to maximize the magnetic flux through the receive coil 973, coil 903-3 is primarily activated (transmit coils 903-1 and 903-2 are not shown), causing the magnetic field in line with the center of the flat coil arrangement to run parallel to the flat coil arrangement and perpendicular to the xz plane.

It can therefore be seen that field-shaping allows the magnetic flux through the receive coil 973 to be maximized regardless of the orientation of the receive coil 973, and therefore the flat coil arrangement is orientation agnostic.

FIG. 10 illustrates an another arrangement of transmit coils 103 for the wireless charging system 1 of FIG. 1, where the coils are arranged in an approximate line, but occupy somewhat different orientations with respect to one another. With this arrangement is also possible to use the field-shaping routine to maximize magnetic flux through the receive coil 973. As can be seen, transmit coil 1003-3 is primarily activated, and transmit coil 1003-4 is secondarily activated.

In any of the possible arrangements of transmit coils, a foreign object is located near to the arrangement of transmit coils the field-shaping routine can be used to shape the field away from the foreign object. This advantageously minimizes loss in transfer power efficiency and minimizes safety hazards associated with inducing currents in a foreign object—for example if the foreign object is a battery, it minimizes the risk of the battery exploding. The field-shaping routine also means that it is not necessary to shut off transmit coils located near to a foreign object.

### MODIFICATIONS AND ALTERNATIVES

Detailed embodiments have been described above. As those skilled in the art will appreciate, a number of modifications and alternatives can be made to the above embodiments whilst still benefiting from the inventions embodied therein. By way of illustration only a number of these alternatives and modifications will now be described.

While the invention has been particularly shown and described with reference to the preferred embodiments thereof, it will be understood by those skilled in the art that various alterations in form and shape may be made therein without departing from the spirit and scope of the invention. In particular, the arrangement, shape and attachment methodology of the charging coils, the individual shapes of the charging coils, the body worn applications, can vary widely within the scope of the invention.

It will be appreciated that the wireless charging system can comprise at least one coil, but preferably comprises two or more. The chargeable device 171 can comprise multiple receive coils, which may for example allow faster charging of the chargeable device 171. Furthermore, the wireless charging system 1 may include any number of channels 200, including a single channel. Accordingly, the resulting magnetic field may be generated by a single transmit coil of a single channel, or by a combination of any number of transmit coils and channels.

It is noted that detection of foreign objects is an optional (but advantageous) feature, and therefore the control unit 105 may not be configured to detect foreign objects.

While in the above description each transmit coil 103 is connected to the same control unit 105, in other embodiments each coil 103 may be connected to separate control units.

The adjacent transmit coils 103 may be connected in any way which allows one or more degrees of freedom—e.g. translational, rotational. Allowing coils to move relative to one another advantageously improves the comfort of a user who uses the wireless charging system—for example the charging belt can conform to the user's morphology.

Preferably, the above-described calibration procedure is performed when the belt is being worn by the use. Also, once the calibration has been performed, the charging device preferably wirelessly charges the charging device while the charging device and chargeable device remain in the same position relative to one another.

The wireless charging system may be worn on top of or under the clothing of a user.

The above-described wireless charging system and belt may be used for charging body-wearable user devices (such as a fitness tracker) as well as implanted/implantable devices (such as a pacemaker). They may also be used to charge any chargeable device, such as a mobile phone.

The wireless charging system can be provided in a belt as described, but it will be appreciated that the system can be incorporated into other items—in particular items which come into contact with a user, such as (but not limited to) a mattress, a blanket, a shirt, a skirt or a jacket.

The wireless charging system may be configured to charge end devices which are body worn or implantable devices.

Also, the array of transmit coils may be optimized to be body worn, for example by being flexible so that it is conformal to different body types/morphologies. The array of transmit coils may also be optimized to be conformal with the shape of the user's body (e.g. adapted to a specific user's body).

The energy source and the transmit coil array may be optimized to minimize their thermal footprint on the user's body whilst maximizing the energy transfer to single or multiple end devices being charged.

The energy source and the transmit coil array are optimized to minimize the specific absorption rate (SAR) developed by the magnetic fields on the body tissue whilst maximizing the energy transfer to single or multiple end devices being charged.

The wireless charging system may be adapted to be agnostic to the orientation, location and shape of the end device being charged.

The wireless charging system may be adapted to shape the magnetic field generated by the transmit coil array to minimize the impact of lossy metallic objects in the vicinity of the device being charged without needing magnetic materials or conductive materials to cover the lossy object.

The wireless charging system may be adapted to charge single or multiple chargeable end devices.

Each of the transmit coils can be of various shapes: round, square and others. Also, each of the transmit coils can be of various winding methods: solenoidal, spiral or a combination of these. Alternatively or additionally, transmit coils can be formed by printing a conductive track on a PCB.

Each of the transmit coils can be tuned through voltage controlled varactor diodes or capacitive banks or similar such known methods that can modify the resonant frequency of the magnetic coils.

Preferably, the control unit is configured to sample and save waveforms of the output currents and output voltages. Furthermore, the control unit is preferably configured to control voltages to varactor diodes to tune the transmit coils. In addition, the control unit is preferably configured to process the voltage and current waveform data and calculate input voltages and clock delays.

In any of the possible arrangements of transmit coils, if multiple foreign objects are located near to the arrangement of transmit coils, the field-shaping routine can be used to shape the field away from the multiple foreign objects.

The charging system may be adapted to optimize the transmitter coil arrangement minimizing the mutual coupling between adjacent neighbours by (a) modifying the shape of each of the transmit coils using the a stream function method that maximizes the magnetic flux incident on the receive coil of the chargeable device, and/or (b) modifying the overlapping area between adjacent neighbouring coils by using a movable hinge between the coils where the location of the hinge changes the overlapping area between the coils which in turn keeps the mutual coupling low even when the transmit coil array flexes.

Various other modifications will be apparent to those skilled in the art and will not be described in further detail here.

1. A wearable device for wirelessly charging a chargeable device, the wearable device comprising:
means for generating a magnetic field for wirelessly charging the chargeable device, wherein the magnetic field generating means comprises at least two transmit coils, each configured to generate a respective component of the magnetic field; and
means for shaping the magnetic field, in dependence on at least one of a location, orientation and shape of the chargeable device, by configuring the respective magnetic field component generated by each transmit coil, whereby to optimize the magnetic field for charging the chargeable device.

2. A wearable device according to claim 1, wherein the at least two transmit coils are mechanically coupled for movement relative to one another whereby to provide the wearable device with flexibility when worn by a user.

3. A wearable device according to claim 1, wherein adjacent transmit coils of the at least two transmit coils are each mechanically coupled to one another, for movement into a plurality of different respective positions relative to one another, to select a position in which, during operation, the adjacent transmit coils are magnetically decoupled from one another, or magnetic coupling (or mutual inductance) between the adjacent coils is minimized.

4. A wearable device according to claim 1, wherein adjacent transmit coils of the at least two transmit coils are mechanically coupled to one another with a coupling configured for rotational movement of at least one of the adjacent coils about an axis and for translational movement of at least one of the adjacent coils relative to the other coil.

5. A wearable device according to claim 4, wherein said coupling is configured for controlling an overlap between the adjacent transmit coils, at a given angle, whereby to reduce or minimize magnetic coupling (or mutual inductance) between the adjacent coils.

6. A wearable device according to claim 1, wherein the magnetic field shaping means comprises means for controlling a phase difference between respective voltage signals applied to each of the at least two transmit coils.

7. A wearable device according to claim 1, wherein the magnetic field shaping means is configured to control a voltage signal applied to each of the at least two transmit coils based on at least one impedance determined for that transmit coil.

8. A wearable device according to claim 7, wherein the at least one impedance determined for a given transmit coil comprises a respective impedance determined as each other of the at least two transmit coils is energized independently.

9. A wearable device according to claim 8, wherein the respective impedance determined as each other of the at least two transmit coils is energized independently is determined based on a mutual inductance between the given transmit coil and the transmit coil that is being energized independently.

10. A wearable device according to claim 1, wherein the wearable device is configured to be worn around the body of a user.

11. A wearable device according to claim 1, wherein the wearable device is configured as a belt, skirt, shirt or jacket.

12. A wearable device according to claim 1, wherein the magnetic field shaping means is operable to configure the respective magnetic field component generated by each coil to shape the magnetic field generated by the generating means whereby to optimize the magnetic field for charging a chargeable device that is implanted in a body of a user.

13. A wearable device according to claim 1, wherein the magnetic field shaping means is operable to configure the respective magnetic field component generated by each coil to shape the magnetic field generated by the generating means whereby to optimize the magnetic field for charging a chargeable device that is not implanted in a body of a user (e.g. a device that is worn on a body of a user).

14. A wearable device according to claim 1, wherein the magnetic field shaping means is operable to configure the respective magnetic field component generated by each coil to shape the magnetic field generated by the generating means away from an object other than the chargeable device.

15. A wearable device according to claim 14, wherein the object other than the chargeable device is capable of magnetically coupling with one or more of the at least two transmit coils.

16. A device for wirelessly charging a chargeable device the wearable device comprising:
means for generating a magnetic field for wirelessly charging the chargeable device, wherein the magnetic field generating means comprises at least two transmit coils, each configured to generate a respective component of the magnetic field; and
wherein adjacent transmit coils of the at least two transmit coils are each mechanically coupled to one another, for movement into a plurality of different respective positions relative to one another, to select a position in which, during operation, the adjacent transmit coils are magnetically decoupled from one another, or magnetic coupling between the adjacent coils is minimized.

17. A method for calibrating an apparatus for charging a chargeable device, the apparatus comprising at least two transmit coils, the method comprising:
(i) supplying current to energize a given transmit coil of the at least two transmit coils and determining an impedance of each other of the at least two transmit coils while current is supplied to the given transmit coil;
(ii) repeating step (i) using each of the at least two transmit coils, in turn, as the given transmit coil;
(iii) determining a voltage signal to be applied to each of the at least two transmit coils, based on the impedances determined in steps (i) and (ii);
(iv) applying the voltage signals determined in step (iii) to the corresponding transmit coils.

18. A method according to claim 17, wherein determining a voltage signal in step (iii) comprises at least one of: determining a phase difference to be applied between respective voltage signals applied to each transmit coil; and determining a respective voltage amplitude of the voltage signals to be applied at each transmit coil.

19. A computer program product for calibrating an apparatus for charging a chargeable device, the apparatus comprising at least two transmit coils, the computer program product comprising instructions for causing a computer-programmable device to perform a method according to claim 17.
